(19) United States
(12) Patent Application Publication
(10) Pub. No.: US 2023/0006353 A1
(43) Pub. Date: Jan. 5, 2023

(54) COUPLED ARRAY ANTENNA AND DEVICE THEREOF

(71) Applicant: QuantumZ Inc., Kaohsiung City (TW)

(72) Inventors: Kun-Yen TU, Kaohsiung City (TW); Meng-Hua TSAI, Kaohsiung City (TW); Wei-Ting LEE, Kaohsiung City (TW); Sin-Siang WANG, Kaohsiung City (TW)

(21) Appl. No.: 17/680,316

(22) Filed: Feb. 25, 2022

(30) Foreign Application Priority Data
Jul. 2, 2021 (TW) 110124487

(51) Int. Cl. H01Q 9/04; H01Q 13/10; H01Q 21/06

(52) U.S. Cl. CPC H01Q 9/045; H01Q 13/106; H01Q 9/0421; H01Q 21/065

(57) ABSTRACT

A coupled array antenna includes a feeding network layer and a plurality of patch antennas disposed on the feeding network layer. A first patch antenna is disposed on the feeding network layer, and a second patch antenna is disposed above and coupled to the first patch antenna without contacting. A plurality of coupled array antennas are connected in series through microstrips to form a coupled array antenna device to maximize the antenna gain and bandwidth.

### CROSS-REFERENCE TO RELATED APPLICATION

This application claims the benefit of Taiwan Patent Application No. 110124487, filed on Jul. 2, 2021, which is hereby incorporated by reference for all purposes as if fully set forth herein.

### BACKGROUND

### Technical Field

The present invention relates to a coupled array antenna and a device thereof, more particularly, to a high-directivity and high-gain multi-layer coupled array antenna using a liquid crystal polymer (LCP) flexible substrate.

### Related Art

Wireless communication technologies have been developing rapidly in recent years. The transmission speed and capacity have increased significantly, and the frequencies used have also become higher. For faster transmission speeds and greater capacities, GHz frequency bands are utilized, that is, a millimeter-wave region. Therefore, the millimeter wave will be a main communication technology for next generation, or referred as 5G. Amongst all components, the liquid crystal polymer(LCP) substrates for carrying components and transmitting signals play an extremely important role.

On the other hand, high directivity and high gain are required in the design of millimeter-wave antennas. Current technologies are insufficient in gain and band width. An array antenna has been proposed to increase the antenna gain in some literatures to overcome foregoing disadvantages. However, the array antenna has relatively narrow bandwidth and requires additional process to manufacture, hence manufacturing costs and antenna sizes are increased. Therefore, such an antenna structure is still to be improved.

### SUMMARY

The present invention provides a coupled array antenna for a millimeter wave with a frequency band in a range of 55 GHz to 72.5 GHz where high directivity and high gain are required. In view of the aforementioned requirements, a multi-layer patch antenna coupling structure is proposed to increase gain and bandwidth of the patch antenna.

The coupled array antenna of the present invention includes a feeding network layer and a plurality of patch antennas disposed on the feeding network layer. A first patch antenna is disposed on the feeding network layer, a second patch antenna is disposed above and coupled to the first patch antenna, and other patch antennas are sequentially disposed above and each coupled to its previous patch antenna.

In an embodiment of the present invention, the coupled array antenna further includes a three-layer substrate having a first layer, a second layer, and a third layer. The feeding network layer is disposed on the surface of the first layer, the first patch antenna is disposed on the surface of the second layer on top of the first layer, and the second patch antenna is disposed on the surface of the third layer on top of the second layer. The total thickness of the three-layer array antenna with substrate is 400 μm. The distance between two adjacent layers of the circuit substrate falling in a range of 150 μm to 250 μm.

In an embodiment of the present invention, the feeding network layer further includes a plurality of metal circuits.

In an embodiment of the present invention, the first patch antenna is slightly larger than the second patch antenna. The length of any side of the second patch antenna is 85% to 95% of a length of a corresponding side of the first patch antenna.

In an embodiment of the present invention, the first patch antenna and the second patch antenna are patch antennas with the same shape. In other embodiments, the first patch antenna and the second patch antenna may alternatively have different geometric shapes such as square, rectangle, circle, ellipse, triangle, sector, ring or ring sector.

In an embodiment of the present invention, the first patch antenna has a half-wavelength resonance condition.

In an embodiment of the present invention, the first patch antenna has a first blind hole of 0.1 mm in diameter, and the second patch antenna has no blind hole.

In an embodiment of the present invention, the wavelength of the second patch antenna is 0.90 to 0.99 times of the wavelength of the first patch antenna.

The present invention further provides a coupled array antenna device. At least two coupled array antennas according to any one of the foregoing embodiments are connected in series through microstrips.

To conclude, although a single-layer patch antenna has a high gain, but the bandwidth is insufficient. For example, a patch antenna gain is 7.16 dBi and a bandwidth ratio is 5.3% at 60 GHz. To increase an antenna bandwidth, a patch antenna with a wavelength 0.93 times of an original wavelength is added 200 μm above the single-layer patch antenna. A three-layer substrate is used to enable the patch antennas to be coupled without contacting. The antenna gain is 6.9 dBi and the bandwidth ratio can be increased to 21.7% at 60 GHz. When a coupled patch antenna is added above a single-layer patch antenna as a set of device, the antenna gain can be further increased to 9.3 dBi and the bandwidth ratio to 11.7% at 60 GHz. When coupled array antennas are arranged to a 1×8 feeding network, the antenna bandwidth is greatly increased where a pass band covers a range of 57.06 GHz to 73 GHz, and the antenna gain approaches to 16 dBi. The patch antennas discussed above utilize LCP flexible sheet for their relatively low loss and low water absorption features that prevent the patch antennas from deforming due to moisture.

### BRIEF DESCRIPTION OF THE DRAWINGS

FIG. 1A is a schematic structural top view of a single-layer patch antenna.

FIG. 1B is a schematic structural side view of a single-layer patch antenna.

FIG. 2A is a schematic structural top view of a coupled array antenna according to the present invention.

FIG. 2B is a schematic structural side view of a coupled array antenna according to the present invention.

FIG. 3A is a schematic structural top view of a coupled array antenna device according to the present invention.

FIG. 3B is a schematic structural side view of a coupled array antenna device according to the present invention.

FIG. 4 is a frequency response diagram of antenna return loss of a coupled array antenna device according to the present invention.

FIG. 5A is a schematic diagram of a 3D radiation field pattern of a single-layer patch antenna.

FIG. 5B is a schematic diagram of a 3D radiation field pattern of a coupled array antenna according to the present invention.

FIG. 5C is a schematic diagram of a 3D radiation field pattern of a coupled array antenna device according to the present invention.

FIG. 6 is a schematic structural diagram of a 1×8 coupled array antenna device according to the present invention.

FIG. 7 is a frequency response diagram of antenna return loss of a 1×8 coupled array antenna device according to the present invention.

FIG. 8 is a schematic diagram of a 3D radiation field pattern of a 1×8 coupled array antenna device according to the present invention.

### DETAILED DESCRIPTION

To make the foregoing features and advantages of the present invention clearer and more comprehensible, specific embodiments are described in detail below with reference to the accompanying drawings.

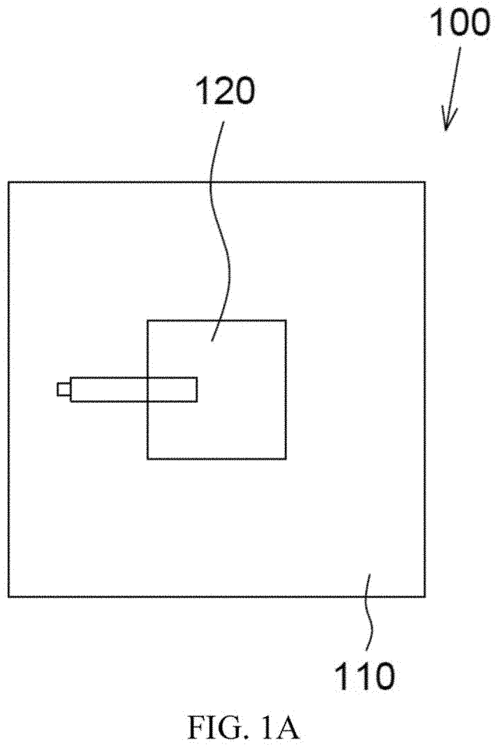

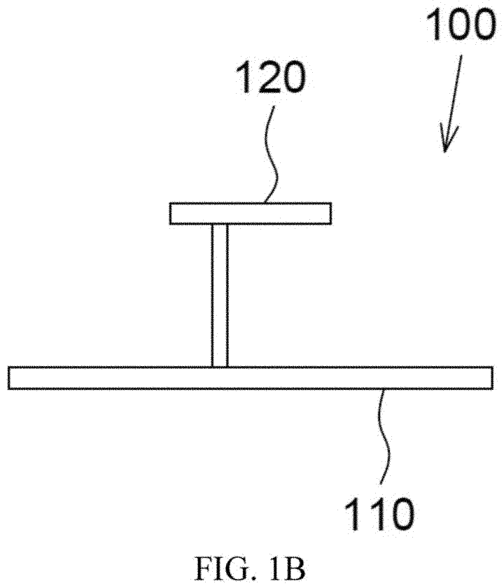

FIG. 1A and FIG. 1B are a schematic structural top view and a schematic structural side view of a single-layer patch antenna respectively. In FIG. 1A and FIG. 1B, the single-layer patch antenna 100 includes a feeding network layer 110 and a patch antenna 120 disposed on the feeding network layer 110.

In an existing single-layer patch antenna structure, a feeding point is electrically connected to the patch antenna from the feeding network layer 110 through a blind hole with a diameter of 0.1 mm, and an antenna gain is 7.16 dBi. However, the antenna has a disadvantage of a narrow bandwidth where the bandwidth ratio is 5.3%.

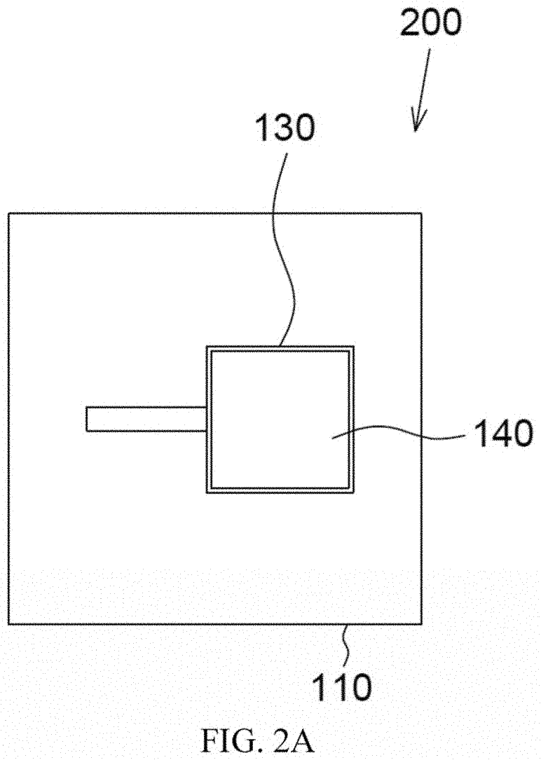

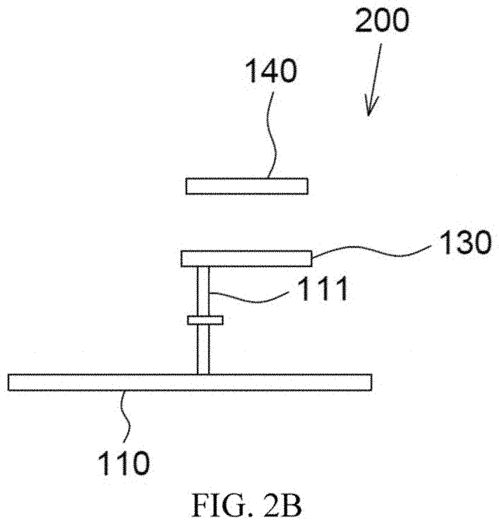

FIG. 2A and FIG. 2B are a schematic structural top view and a schematic structural side view of a coupled array antenna according to the present invention respectively. In FIG. 2A and FIG. 2B, the coupled array antenna 200 includes a feeding network layer 110, a first patch antenna 130 disposed on an upper layer of the feeding network layer 110, and a second patch antenna 140 disposed above and coupled to the first patch antenna 130.

In this embodiment, the coupled array antenna further includes a three-layer substrate having a first layer, a second layer, and a third layer. The feeding network layer 110 is disposed on a surface of the first layer. The first patch antenna 130 is disposed on a surface of the second layer on top of the first layer. The second patch antenna 140 is disposed on a surface of the third layer on top of the second layer. A total thickness of the three-layer circuit substrate is 400 μm.

The three-layer circuit substrate may be an epoxy resin, polyphenylene-oxide resin, fluorine-based resin, or LCP substrate.

In this embodiment, the operation frequency of the coupled array antenna is ranged from 57.06 GHz to 73 GHz.

In this embodiment, the structure of the patch antenna changes from an existing single-layer structure to a double-layer structure to improve the antenna bandwidth, and the bandwidth ratio of the antenna is increased to 21.7%.

The feeding network layer 110 is disposed on the first layer of the three-layer substrate, to be electrically connected to a signal source.

The feeding network layer 110 further includes a plurality of metal circuits, an impedance transformer, a power splitter, and a signal source line.

One end of each of the plurality of metal lines is electrically connected to a first blind hole, one end of the impedance transformer is electrically connected to the other end of each of the plurality of metal lines, one end of the power splitter is electrically connected to the other end of the impedance transformer, and the signal source line is electrically connected to the other end of the power splitter and the signal source.

In this embodiment, the first patch antenna 130 is slightly larger than the second patch antenna 140. The first patch antenna 130 and the second patch antenna 140 are patch antennas in a same shape.

In other embodiments, the first patch antenna 130 and the second patch antenna 140 each may have a geometric shape of square, rectangle, circle, ellipse, triangle, sector, ring, or ring sector.

In this embodiment, the first patch antenna 130 has a half-wavelength resonance condition.

The first patch antenna 130 has a first blind hole 111 of 0.1 mm in diameter, and the second patch antenna 140 has no blind hole.

The first blind hole 111 runs through the second layer of the three-layer substrate, and is electrically connected to the feeding network 110 layer and the first patch antenna 130.

Feeding may be performed from a side surface or a bottom surface of the first patch antenna 130, or a combination thereof.

The second patch antenna 140 has no blind hole, and a signal of the second patch antenna 140 is transmitted from the first patch antenna 130 through a conductive material in the blind hole, and is transmitted to the second patch antenna 140 in a non-contact electrical coupling manner.

In the present invention, a wavelength of the second patch antenna is 0.9 to 0.99 times a wavelength of the first patch antenna. In this embodiment, the wavelength of the second patch antenna is 0.93 times the wavelength of the first patch antenna.

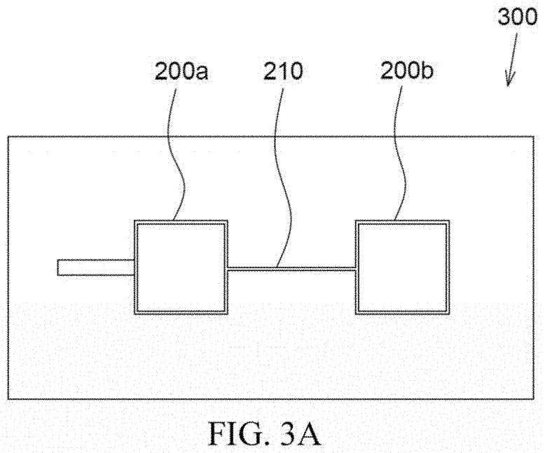

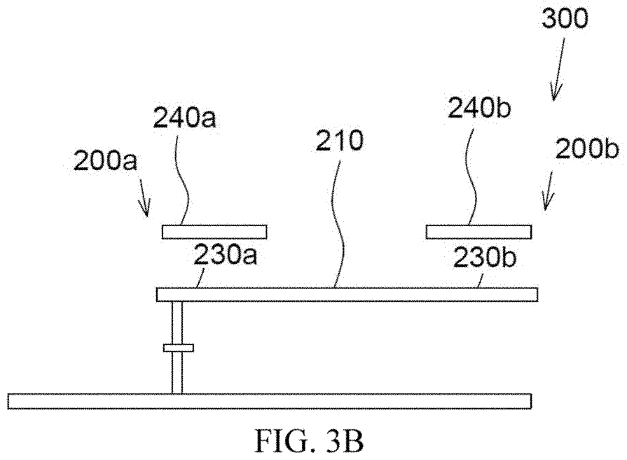

FIG. 3A and FIG. 3B are a schematic structural top view and a schematic structural side view of a coupled array antenna device according to the present invention respectively. In FIG. 3A and FIG. 3B, the coupled array antenna device 300 includes two coupled array antennas 200a and 200b, and a microstrip 210 connects the two coupled array antennas 200a and 200b in series.

In this embodiment, the coupled array antenna 200a is connected to the coupled array antenna 200b in series to increase an antenna gain of the coupled array antenna. The first patch antennas 230a and 230b are connected by the microstrip 210. In addition, the second patch antenna 240a is disposed above the first patch antenna 230a, a second patch antenna 240b is disposed above the first patch antenna 230b, and the two second patch antennas are not connected to each other.

In other embodiments of the present invention, the quantity of coupled array antennas connected in series is not limited to two, but may alternatively be three or more. The quantity of stacked layers of each coupled array antenna is not limited to two, but may alternatively be three or more.

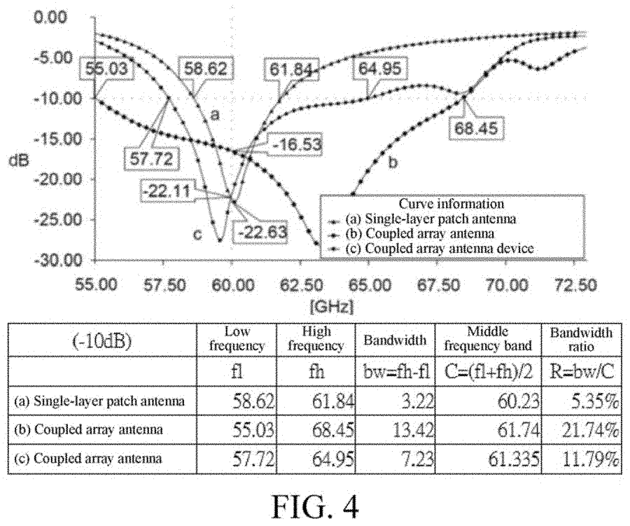

FIG. 4 is a frequency response diagram 400 of antenna return loss of a coupled array antenna and a device thereof according to the present invention. As shown in FIG. 4, the coupled array antenna and the coupled array antenna device of the present invention have bandwidth ratios of 21.7% and 11.7% compared to 5.3% of existing single-layer patch antenna respectively, thereby significant improvements of the bandwidth ratio. A bandwidth is obtained according to a difference between high and low frequencies, and a middle frequency band is obtained by averaging the high and low frequencies, to calculate a required bandwidth ratio of an antenna.

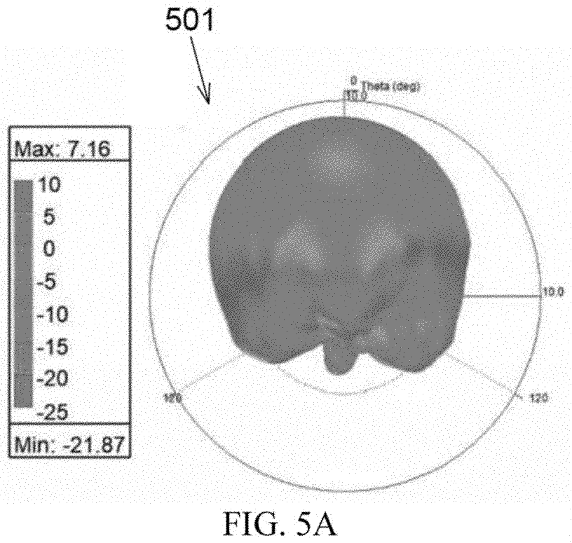

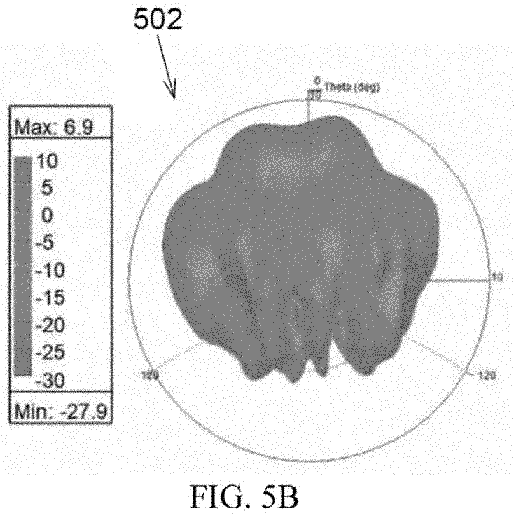

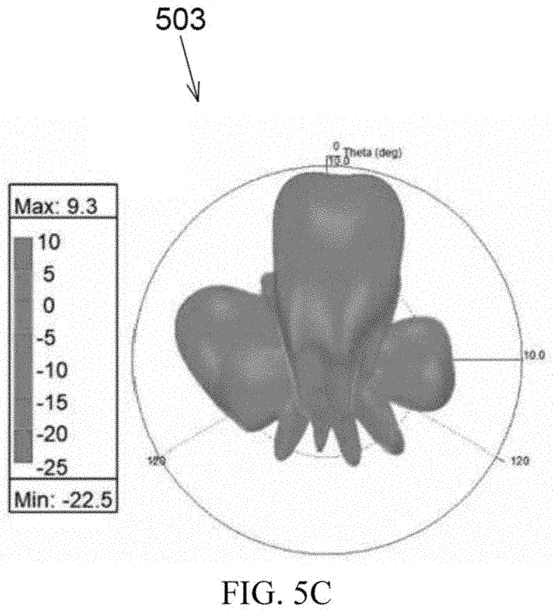

Referring to FIG. 5A to FIG. 5C, FIG. 5A is a schematic diagram 501 of a 3D radiation field pattern of a conventional single-layer patch antenna, FIG. 5B is a schematic diagram 502 of a 3D radiation field pattern of a coupled array antenna according to the present invention, and FIG. 5C is a schematic diagram 503 of a 3D radiation field pattern of a coupled array antenna device according to the present invention. As shown in FIG. 5A to FIG. 5C, the radiation field patterns of the antennas indicate that antenna gains of a single-layer patch antenna and the coupled array antenna of the present invention are 7.16 dBi and 6.9 dBi respectively, and the coupled array antenna device of the present invention has an obviously higher antenna gain with a value of 9.3 dBi.

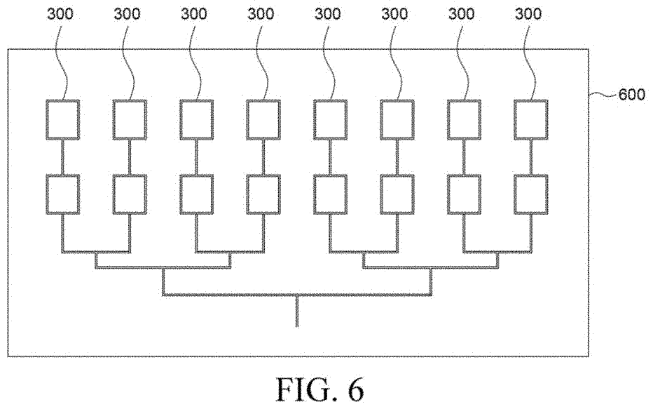

FIG. 6 is a schematic structural diagram of a 1×8 coupled array antenna device according to the present invention. In this embodiment, coupled array antenna devices are arranged into the 1×8 coupled array antenna device, that is, a coupled array antenna device that converts one input signal into a set of eight signals. The coupled array antenna device 300 has a three-layer structure with a total thickness of 400 μm. A feeding network layer is disposed on a first layer of a three-layer substrate. The antenna feeds in from below through a first blind hole to the first patch antenna disposed on a second layer of the three-layer substrate, and then couples the signal to a second patch antenna disposed on a third layer of the three-layer substrate.

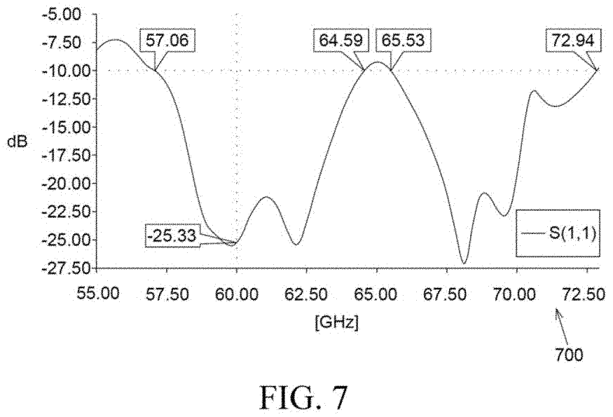

FIG. 7 is a frequency response diagram 700 of antenna return loss of a 1×8 coupled array antenna device according to the present invention. As shown in FIG. 7, except for poor matching of a pass band in the range of 64.59 GHz and 65.53 GHz, other frequency bands in the range of 57.06 GHz and 73 GHz have obvious enhancement effects.

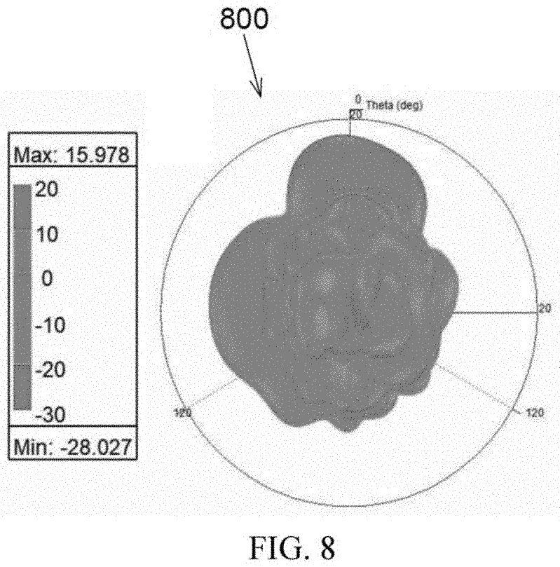

FIG. 8 is a schematic diagram 800 of a 3D radiation field pattern of a 1×8 coupled array antenna device according to the present invention. As shown in FIG. 8, an antenna gain can reach nearly 16 dBi.

In summary, a coupled array antenna and a device thereof are provided in the present invention. Two patch antennas are coupled by using a three-layer circuit substrate, an antenna gain is increased to 6.9 dBi and a bandwidth ratio is increased to 21.7% at 60 GHz. Further, a coupled patch antenna is added above a single-layer patch antenna to increase the antenna gain. The antenna gain may be further increased to 9.3 dBi and the bandwidth ratio is increased to 11.7% at 60 GHz. When coupled array antennas arranged to a 1×8 feeding network, the antenna bandwidth is greatly increased where a pass band covers a range of 57.06 GHz to 73 GHz, and the antenna gain approaches to 16 dBi. The patch antennas in some embodiments utilize LCP flexible substrates for their relatively low loss and low water absorption features that prevent the patch antennas from being easily deformed by moisture.

Although the present invention is disclosed above with the foregoing embodiments, the embodiments are not intended to limit the present invention. The equivalent replacements of changes and refinements made by any person skilled in the art without departing from the spirit and scope of the present invention shall still fall within the protection scope of the present invention.

What is claimed is:

1. A coupled array antenna, comprising:
a feeding network layer; and
a plurality of patch antennas, disposed on the feeding network layer, wherein
a first patch antenna is disposed on the feeding network layer;
a second patch antenna is disposed above and coupled to the first patch antenna; and
other patch antennas are sequentially disposed above and each coupled to its previous patch antenna.

2. The coupled array antenna of claim 1, wherein the coupled array antenna further includes a multi-layer circuit substrate; the feeding network layer is disposed on a surface of a first layer, the first patch antenna is disposed on a surface of a second layer, the second patch antenna is disposed on a surface of a third layer, and the other patch antennas are sequentially disposed on each corresponding layer of the circuit substrate respectively, a distance between two adjacent layers of the circuit substrate falling in a range of 150 μm to 250 μm.

3. The coupled array antenna of claim 1, wherein a length of any side of the second patch antenna is 85% to 95% of a length of a corresponding side of the first patch antenna.

4. The coupled array antenna of claim 1, wherein an area of the first patch antenna is slightly larger than an area of the second patch antenna.

5. The coupled array antenna of claim 1, wherein the first patch antenna and the second patch antenna are patch antennas in a same geometric shape.

6. The coupled array antenna of claim 1, wherein each of the patch antennas may be a patch antenna in a geometric shape being one of a square, a rectangle, a circle, an ellipse, a triangle, a sector, a ring, or a ring sector.

7. The coupled array antenna of claim 1, wherein the first patch antenna is a patch antenna with a half-wavelength resonance condition.

8. The coupled array antenna of claim 1, wherein the first patch antenna has a first blind hole, a diameter of the first blind hole being less than 0.18 mm.

9. The coupled array antenna of claim 1, wherein a wavelength of the second patch antenna is 0.90 to 0.99 times a wavelength of the first patch antenna.

10. A coupled array antenna device, comprising the coupled array antenna of claim 1, and connecting two coupled array antennas in series through a microstrip.

11. The coupled array antenna device of claim 10, wherein the coupled array antenna further includes a multi-layer circuit substrate; the feeding network layer is disposed on a surface of a first layer, the first patch antenna is disposed on a surface of a second layer, the second patch antenna is disposed on a surface of a third layer, and the other patch antennas are sequentially disposed on each corresponding layer of the circuit substrate respectively, a distance between two adjacent layers of the circuit substrate falling in a range of 150 μm to 250 μm.

12. The coupled array antenna device of claim 10, wherein a length of any side of the second patch antenna is 85% to 95% of a length of a corresponding side of the first patch antenna.

13. The coupled array antenna device of claim 10, wherein an area of the first patch antenna is slightly larger than an area of the second patch antenna.

14. The coupled array antenna device of claim 10, wherein the first patch antenna and the second patch antenna are patch antennas in a same geometric shape.

15. The coupled array antenna device of claim 10, wherein each of the patch antennas may be a patch antenna in a geometric shape being one of a square, a rectangle, a circle, an ellipse, a triangle, a sector, a ring, or a ring sector.

16. The coupled array antenna device of claim 10, wherein the first patch antenna is a patch antenna with a half-wavelength resonance condition.

17. The coupled array antenna device of claim 10, wherein the first patch antenna has a first blind hole, a diameter of the first blind hole being less than 0.18 mm.

18. The coupled array antenna device of claim 10, wherein a wavelength of the second patch antenna is 0.90 to 0.99 times a wavelength of the first patch antenna.
